(19) United States
(12) Patent Application Publication
(10) Pub. No.: US 2011/0267192 A1
(43) Pub. Date: Nov. 3, 2011

(54) Individualized Baggage Tracking And Notification System

(75) Inventors: Stuart O. Goldman, Scottsdale, AZ (US); Karl F. Rauscher, Emmaus, PA (US)

(73) Assignee: Alcatel-Lucent USA Inc., Murray Hill, NJ (US)

(21) Appl. No.: 12/769,229

(22) Filed: Apr. 28, 2010

(51) Int. Cl. G08B 13/14

(52) U.S. Cl. 340/568.1

(57) ABSTRACT

An individualized baggage tracking and notification system provides airline baggage tracking information to individual customers for purposes of customer convenience and/or theft avoidance. The individualized baggage tracking information may indicate, for each of one or more baggage items affiliated with the customer, indicia of one or more baggage handling nodes visited by the baggage items, indicia of recorded arrival times of the baggage items at the visited nodes, indicia of one or more baggage handling nodes not yet visited by the baggage items and indicia of projected arrival times of the baggage items at those nodes. In an instance where a customer baggage item has reached a terminating node (e.g., a baggage carousel), the system may indicate the arrival time of the baggage item at the terminating node; or in the instance the baggage item has not yet reached the terminating node, the system may indicate a projected arrival time of the baggage item at the terminating node.

### FIELD OF THE INVENTION

This invention relates generally to commercial airline baggage handling and, more particularly to a customer service that provides baggage status information to individual customers for purposes of customer convenience and/or theft avoidance.

### BACKGROUND OF THE INVENTION

Commercial airline travel is well known mode of transportation for carrying passengers and their baggage (e.g., suitcases, luggage and other items) to various domestic or international destinations. Commonly, sometime prior to boarding the aircraft, customers will check one or more baggage items with a skycap or ticket agent, whereupon the bags are tagged with identification information (e.g., flight number, destination airport codes, ticket number and the like) so as to enable a baggage handling system to manage transport and delivery of the baggage to the passenger's aircraft (at the departure airport) and to a designated delivery platform, such as a baggage carousel (at the destination airport). The baggage handling system commonly comprises some combination of baggage handlers, transport belts, bag carts and the like, depending on the resources and capacity of the departure and destination airports.

A problem that arises, however, is that after relinquishing custody of their baggage to the baggage handling system, passengers are typically not provided status associated with their individual baggage items at either the departure or destination airport. Most particularly at the destination airport, this can contribute to customer anxiety and possible baggage theft. Passengers are usually informed which baggage carousel is handling the bags for a given flight, and might even be provided an indication of when the first bags from that flight might arrive at the carousel, but they do not know when, or if, their individual baggage items will arrive at the carousel or other designated delivery platform.

### SUMMARY OF THE INVENTION

These problems are addressed and a technical advance is achieved in the art by an individualized baggage tracking and notification system that provides airline baggage tracking information to individual customers for purposes of customer convenience and/or theft avoidance. Embodiments described herein may advantageously provide, for example, timing and status information associated with delivery and/or projected delivery of baggage to designated reference nodes, including without limitation, a baggage carousel or other designated delivery platform.

In one embodiment, there is provided an individualized baggage tracking and notification system comprising one or more detector platforms, a database platform, a processing platform and a notification platform. The detector platforms are configured to receive status information associated with a plurality of baggage items in transit throughout an airport baggage handling system comprising a plurality of nodes; and the database platform is configured to maintain timing information including nominal transit times between reference nodes of the plurality of nodes. The processing platform processes the status information and timing information to produce for at least one customer, individualized baggage tracking information including, for each of one or more baggage items affiliated with the customer, one or more of: indicia of designated reference nodes visited by the baggage items, defining respective first reference nodes; indicia of recorded arrival times of one or more baggage items at the first reference nodes; indicia of designated reference nodes likely to be negotiated by the baggage items, defining respective second reference nodes; and indicia of projected arrival times of one or more baggage items at the second reference nodes. The notification platform communicates at least a portion of the individualized baggage tracking information to individual customers and/or baggage handling agents.

In another embodiment, there is provided a method comprising receiving status information associated with a plurality of baggage items in transit throughout an airport baggage handling system comprising a plurality of nodes; receiving timing information including nominal transit times between reference nodes of the plurality of nodes; processing the status information and timing information to produce for at least one customer, individualized baggage tracking information including, for each of one or more baggage items affiliated with the customer, one or more of: indicia of designated reference nodes visited by the baggage items, defining respective first reference nodes; indicia of recorded arrival times of one or more baggage items at the first reference nodes; indicia of designated reference nodes yet to be negotiated by the baggage items, defining respective second reference nodes; and indicia of projected arrival times of one or more baggage items at the second reference nodes; and communicating one or more instances of individualized baggage tracking information to a corresponding one or more individual customers.

In still another embodiment, there is provided a method comprising receiving a baggage tracking information service request initiated by a customer having one or more baggage items in transit throughout an airport baggage handling system comprising a plurality of nodes; receiving status information associated with one or more baggage items; receiving timing information including nominal transit times between reference nodes of the plurality of nodes; producing individualized baggage tracking information including, for each of the one or more baggage items of the customer, one or more instances of status and timing information; and communicating at least a portion of the individualized baggage tracking information to the customer.

### BRIEF DESCRIPTION OF THE DRAWINGS

The foregoing and other advantages of the invention will become apparent upon reading the following detailed description and upon reference to the drawings in which:

FIG. 1 is a block diagram of an individualized baggage tracking and notification system according to an exemplary embodiment of the invention;

FIG. 2 depicts an airport baggage handling system comprising a plurality of nodes, including detector platforms configured to receive status information of customer baggage items according to an exemplary embodiment of the invention;

FIG. 3 is a table identifying exemplary baggage handling nodes at a departure airport and destination airport; and

FIG. 4 is a flowchart of steps performed by a processing platform of an individualized baggage tracking and notification system according to an exemplary embodiment of the invention.

### DESCRIPTION OF THE PREFERRED EMBODIMENT(S)

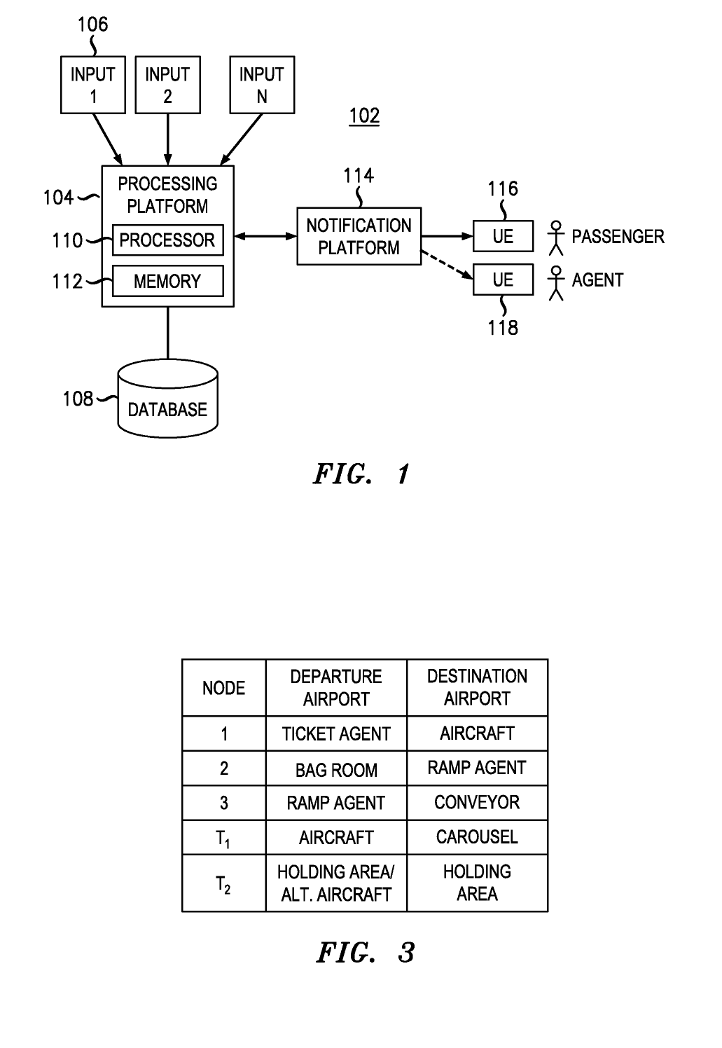

FIGS. 1-4 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates an individualized baggage tracking and notification system 102 according to embodiments of the invention. As shown, the system 102 comprises a processing platform 104, a plurality of detector platforms 106, a database 108 and a notification platform 114 operably connected to user equipment (UE) 116, 118 of one or more customers (e.g., airline passengers) or agents. As will be appreciated, the platforms 104, 106, 114 and the database 108 are functional elements that may reside in one or more physical devices or structures.

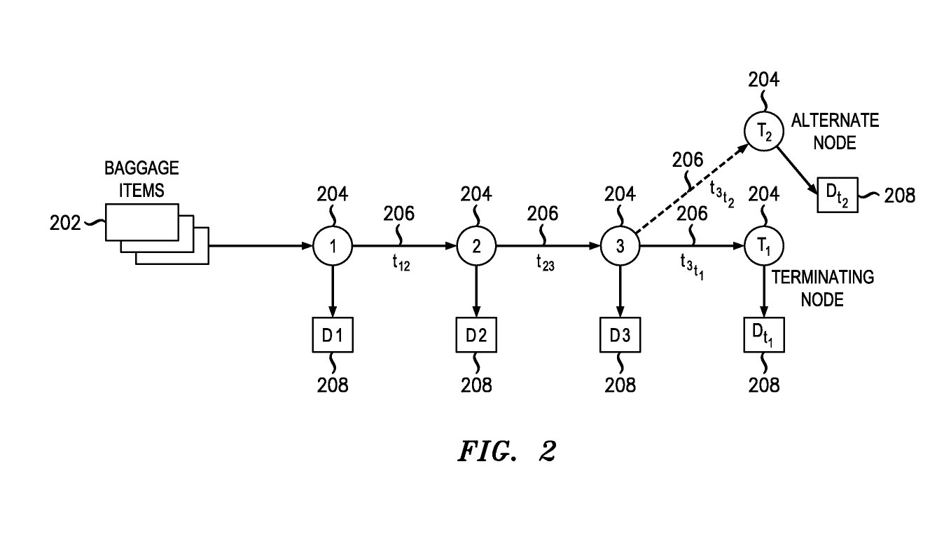

In one embodiment, the processing platform 104 obtains status information from the detector platforms 106 associated with a plurality of baggage items in transit throughout an airport baggage handling system. The baggage items may comprise checked baggage items, or generally any passenger items that have been relinquished to the baggage handling system for transport and/or delivery. Advantageously, the baggage items will include identification information (e.g., flight number, destination airport codes, ticket number and the like) so as to enable a baggage handling system to manage transport of the baggage throughout various baggage handling nodes. As will be described in greater detail in relation to FIG. 2 and FIG. 3, the baggage handling nodes may correspond to particular agents, devices or locations dispersed throughout an airport baggage handling system, and the nodes may be separately defined for departure and destination airport.

The detector platforms 106 may characterize, for example and without limitation, data terminals, sensors, or the like having the ability to access or receive airline baggage status information relative to the plurality of baggage handling nodes of the airport baggage handling system. The status information comprises, in one embodiment, indicia of baggage items having been received and processed at particular nodes (defining “visited” nodes) and indicia of recorded arrival times of the baggage items at the visited nodes. For example and without limitation, the status information may be acquired by designated agents or devices scanning the bag check tags of baggage items as they are received at various nodes, and entering the scan data into a computer terminal or the like so as to acknowledge reception of the baggage items at the respective nodes and to record a time that they were received.

Additionally, in one embodiment, the processing platform 104 obtains reference timing information from the database platform 108 including nominal transit times between various reference nodes. For example, in an instance of reference nodes that are connected by a transport belt, conveyer or the like, the timing information may be derived based on known distance between nodes and a known speed of the transport belt. Alternatively or additionally, reference timing information may be based on historical averages, estimates, or generally any manner of predicting transit times between nodes.

In one embodiment, the processing platform 104 receives and processes the status information and timing information to produce individualized baggage tracking information for particular customers. The individualized baggage tracking information may include, for example, depending on the progress of the customer's baggage items throughout an airport baggage handling system: indicia of one or more visited nodes, recorded arrival times at the visited nodes, indicia of one or more forthcoming nodes (i.e., not yet visited); and/or projected arrival times of the customer's baggage items at the forthcoming nodes. The baggage tracking information is “individualized” in the sense that baggage tracking information is produced for different individual customers, each customer having one or more unique baggage items in transit through the baggage handling system. The baggage tracking information will also be individualized with respect to different individual baggage items, in the sense that different individual baggage items will generally have unique arrival times or projected arrival times at designated nodes relative to other baggage items associated with a particular customers or particular flights.

As shown, the processing platform 104 includes a processor 110 and memory 112. The term “processor” as used herein is intended to include one or more processing devices, including a central processing unit (CPU) or other processing circuitry, including but not limited to one or more signal processors, one or more integrated circuits, and the like. The term “memory” as used herein is intended to include memory associated with a processor or CPU, such as RAM, ROM, a fixed memory device (e.g., hard drive), or a removable memory device (e.g., diskette or CDROM).

Accordingly, software instructions or code for performing the methodologies of the invention, described herein, may be stored in one or more of the associated memory devices, e.g., ROM, fixed or removable memory, and, when ready to be utilized, loaded into RAM and executed by the CPU. That is, the CPU may execute software instructions residing in computer-readable signal-bearing media of the processing platform 104 to perform steps associated with receiving and processing status information and timing information to produce individualized baggage tracking information.

The notification platform 114 operates to communicate individualized baggage tracking information to one or more end users, in one embodiment, by delivering the individualized baggage tracking information to user equipment (UE) 116, 118 associated with customers or agents. In one embodiment, the individualized baggage tracking information is provided as a service to particular individual customers having registered for the service. Depending on business model, the service may be offered, for example and without limitation, on a subscription basis, on the basis of a ticket surcharge, fee or the like, or may be offered on the basis of customer status or privileges such as first-class passengers or frequent fliers. The individualized baggage tracking information associated with a customer having multiple baggage items may be communicated individually (i.e., separately for each baggage item) or collectively.

As will be appreciated, the notification platform 114 may be implemented in any of several forms depending on the communication modality supported by the UE 116, 118. In one example, the notification platform 114 utilizes wireless resources to communicate individualized baggage tracking information to UE 116, 118 comprising mobile phones, PDUs or the like. The wireless resources 108 may comprise narrowband frequency modulated channels, wideband modulated signals, broadband modulated signals, time division modulated slots, carrier frequencies, frequency pairs or generally any medium for communicating information from the notification platform 114 to the UE 116, 118. The wireless resources 108 may implement air interface technologies including but not limited to, CDMA, TDMA, GSM, UMTS or IEEE 802.11.

Now turning to FIG. 2, there is shown a generic representation of an airport baggage handling system comprising a plurality of nodes 204. The nodes 204 may correspond, for example and without limitation, to particular agents, devices or locations dispersed throughout an airport baggage handling system, and the nodes may be separately defined for departure and destination airport.

In the representation shown, baggage items 202 are received at a first node (“node 1”) and continue through a second node (“node 2”), third node (“node 3”) and a nominal terminating node (“node T₁”). Optionally, in some instances, the baggage items may be delivered to an alternative node (as shown, “node T₂”). Between consecutive nodes the baggage items traverse respective paths 206; and for each path there is defined a nominal transit time. As shown, for example, t₁₂ defines the transit time between nodes 1 and 2, t₂₃ defines the transit time between nodes 2 and 3, and so forth. Still further, in the representation shown, each respective node is operably connected to a detector platform (as shown (D₁, D₂, D₃, D_{T1} and D_{T2}) for receiving baggage status information associated with the baggage items as they are received at the respective nodes.

As will be appreciated, the number and/or characteristics of the nodes 204 and paths 206 may differ depending on the functionality, methodology or resources of the baggage handling system, airport topology, loading conditions or the like. Moreover, between any two nodes, the path between the nodes and/or the transit time between the nodes are subject to change from time to time based on changes in any of the aforementioned factors. Nevertheless, it is contemplated that for any particular moment in time, the topology of nodes and paths, and nominal transit times between nodes are sufficiently defined so as to facilitate tracking of baggage items throughout the various nodes and to predict arrival times of customer baggage items at least the nominal terminating node T₁.

In one embodiment, the nodes and paths are separately defined at the departure and destination airport. Referring to FIG. 3 as one example and without limitation, at the departure airport: node 1 may define a ticket agent, node 2 a bag room, node 3 a ramp agent, node T1 the departure aircraft and the alternate node T2 a holding area or alternative departure aircraft (e.g., in the instance that the passenger is delayed or diverted to an alternative aircraft). At the destination airport: node 1 may define the arriving aircraft, node 2 a ramp agent, node 3 a conveyer, node T1 a baggage carousel for nominally receiving the baggage items from the arriving aircraft, and the alternate node T2 a holding area (e.g., in the instance that the baggage items are diverted from the baggage carousel to a holding area). Between consecutive nodes the baggage items traverse respective paths (not shown in relation to FIG. 3) and for each path there is defined a nominal transit time based, for example, on known distance between nodes and a known speed of transport, or based on historical averages, estimates, or the like to facilitate tracking of baggage items throughout the various nodes and to predict arrival times of customer baggage items at least the nominal terminating node T₁.

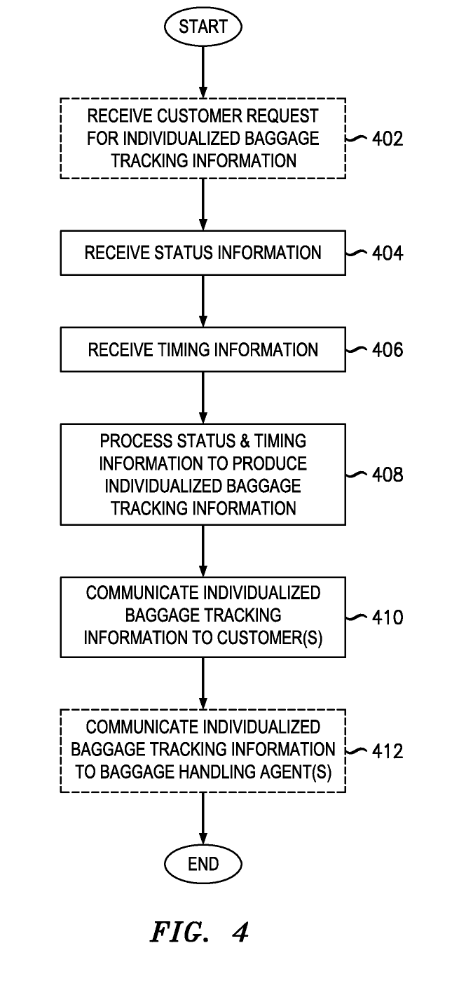

Now turning to FIG. 4, there is shown a flowchart for implementing an individualized baggage tracking and notification system according to an exemplary embodiment of the invention. The method is implemented, in one embodiment, by a processing platform of a baggage tracking and notification system such as described in relation to FIG. 1, presuming a topology of nodes and paths have been defined such as described in relation to FIG. 2 or FIG. 2 to facilitate tracking of baggage items throughout the various nodes and to predict arrival times of customer baggage items at least the nominal terminating node T₁.

Optionally, at step 402, the individualized baggage tracking and notification system is implemented responsive to a customer request. For example, a passenger may request individualized tracking information associated with one or more of his or her checked baggage items in process through a baggage handling system. Referring to FIG. 1, for example, the request may be initiated by the customer user equipment (UE) 116 (e.g., mobile phone, PDU) and communicated to the processing platform via the notification platform. Alternatively or additionally, individualized baggage tracking and notification service may be provided to customers on a subscription basis, or based on frequent flier status or the like without requiring a customer request.

At step 404, the processing platform obtains status information associated with a plurality of baggage items in transit throughout an airport baggage handling system. In one embodiment, the status information is obtained from detector platforms 106 comprising data terminals, sensors, or the like residing at various nodes of the airport baggage handling system. The status information comprises, in one embodiment, indicia of baggage items having been received and processed at particular nodes (defining “visited” nodes) and indicia of recorded arrival times of the baggage items at the visited nodes.

At step 406, the processing platform obtains timing information including nominal transit times between various reference nodes. In one embodiment, the timing information is maintained within the database platform 108 and obtained upon request by the processing platform. Alternatively or additionally, the timing information may reside within one or more detector platforms, or the memory 112 of the processing platform, or may be independently derived by the processing platform.

At step 408, the processing platform processes the status and timing information to produce individualized baggage tracking information for particular customers. The individualized baggage tracking information may include, for example, depending on the progress of the customer's baggage items throughout an airport baggage handling system: indicia of one or more visited nodes, recorded arrival times at the visited nodes, indicia of one or more forthcoming nodes (i.e., not yet visited); and/or projected arrival times of the customer's baggage items at the forthcoming nodes. The baggage tracking information is “individualized” in the sense that baggage tracking information is produced for different individual customers, each customer having one or more unique baggage items in transit through the baggage handling system. The baggage tracking information will also be individualized with respect to different individual baggage items, in the sense that different individual baggage items will generally have unique arrival times or projected arrival times at designated nodes relative to other baggage items associated with a particular customers or particular flights.

At step 410, the processing platform, via the notification platform, communicates the individualized baggage tracking information to customers. As will be appreciated, the individualized baggage tracking information may be communicated to customers in any of several modalities, depending on the modalities supported by the customer UE 116. For example and without limitation, the individualized baggage tracking information may be communicated by voice, text message, email or web interface. The individualized baggage tracking information may be communicated in a single message or distributed among multiple messages.

Optionally, responsive to one or more instances of baggage tracking information, the customer may initiate a new request, or modify or supplement the original request. For example, it is contemplated a customer might receive indicia of a projected arrival time of one or more baggage items at a nominal terminating node (e.g., baggage carousel), but for reasons of delay or diversion, the customer will not be available to receive the baggage items at the projected time. In such case, the customer may initiate a request (i.e., a new request) to divert the baggage items to an alternative terminating node (such as a holding area) to reduce the likelihood of theft of the baggage items. Or the customer may supplement or modify a request so as to identify fewer or greater number of baggage items to be tracked. It is contemplated, for example, a customer may wish to track baggage items of other family members or business colleagues or the like, in addition to his or her own baggage items (or alternatively, remove certain baggage items to be tracked), and to do so it may be necessary to supplement or modify an initial request.

Optionally, at step 412, the individualized baggage tracking information associated with a particular customer may be communicated to a baggage handling agent. This can be utilized, for example, to facilitate special handling and/or diversion of certain baggage items by the agent on behalf of the customer.

The specific exemplary embodiments of the present invention have been described with some aspects simplified or omitted. Those skilled in the art will appreciate variations from these embodiments that fall within the scope of the invention. The described embodiments are to be considered in all respects only as illustrative and not restrictive. Although the invention is described in relation to commercial airline baggage handling, the invention may be deployed to provide individualized tracking information of designated items within virtually any delivery system defining a topology of nodes and paths with nominal transit times between nodes.

The scope of the invention is, therefore, indicated by the appended claims rather than by the foregoing description. All changes that come within the meaning and range of equivalency of the claims are to be embraced within their scope.

What is claimed is:

1. A system comprising:
one or more detector platforms, configured to receive status information associated with a plurality of baggage items in transit throughout an airport baggage handling system comprising a plurality of nodes;
a database platform, configured to maintain timing information including nominal transit times between reference nodes of the plurality of nodes; and
a processing platform, operable to process the status information and timing information to produce for at least one customer, individualized baggage tracking information including, for each of one or more baggage items affiliated with the customer, one or more of: indicia of designated reference nodes visited by the baggage items, defining respective first reference nodes; indicia of recorded arrival times of one or more baggage items at the first reference nodes; indicia of designated reference nodes likely to be negotiated by the baggage items, defining respective second reference nodes; and indicia of projected arrival times of one or more baggage items at the second reference nodes.

2. The system of claim 1, further comprising a notification platform operable to communicate at least a portion of respective individualized baggage tracking information to individual customers.

3. The system of claim 1, further comprising a notification platform operable to communicate at least a portion of respective individualized baggage tracking information to one or more baggage handling agents.

4. The system of claim 1, wherein the processing platform is operable to produce a redirection instruction, causing one or more baggage items having visited the first reference node to be redirected to a reference node other than the second reference node.

5. A method comprising:
receiving status information associated with a plurality of baggage items in transit throughout an airport baggage handling system comprising a plurality of nodes;
receiving timing information including nominal transit times between reference nodes of the plurality of nodes;
processing the status information and timing information to produce for at least one customer, individualized baggage tracking information including, for each of one or more baggage items affiliated with the customer, one or more of: indicia of designated reference nodes visited by the baggage items, defining respective first reference nodes; indicia of recorded arrival times of one or more baggage items at the first reference nodes; indicia of designated reference nodes yet to be negotiated by the baggage items, defining respective second reference nodes; and indicia of projected arrival times of one or more baggage items at the second reference nodes; and
communicating one or more instances of individualized baggage tracking information to a corresponding one or more individual customers.

6. The method of claim 5, wherein the individualized baggage transit information comprises for at least one customer, indicia of designated reference nodes visited by the baggage items of the customer.

7. The method of claim 6, wherein the individualized baggage transit information further comprises for the at least one customer, indicia of recorded arrival times of the baggage items of the customer at the designated reference nodes.

8. The method of claim 5, wherein the individualized baggage transit information comprises for at least one customer, indicia of designated reference nodes yet to be negotiated by the baggage items of the customer.

9. The method of claim 8, wherein the individualized baggage transit information further comprises for the at least one customer, indicia of projected arrival times of the baggage items of the customer at the designated reference nodes.

10. The method of claim 5, wherein the individualized baggage transit information comprises, in an instance of one or more baggage items of a customer having reached a terminating node, indicia of recorded arrival times of the one or more baggage items at the terminating node.

11. The method of claim 5, wherein the individualized baggage transit information comprises, in an instance of one or more baggage items of a customer not yet having reached a terminating node, indicia of projected arrival times of the one or more baggage items at the terminating node.

12. The method of claim 5, further comprising a step of producing a redirection instruction, causing one or more baggage items having visited the first reference node to be redirected to an alternative reference node other than the second reference node.

13. The method of claim 12, wherein the individualized baggage transit information comprises, in an instance of one or more baggage items of a customer having been redirected to an alternative reference node, indicia of one of: recorded arrival times and projected arrival times of the one or more baggage items at the alternative reference node.

14. The method of claim 5, further comprising a step of communicating one or more instances of individualized baggage tracking information to one or more baggage handling agents.

15. A method comprising:
receiving a baggage tracking information service request initiated by a customer having one or more baggage items in transit throughout an airport baggage handling system comprising a plurality of nodes;
receiving status information associated with one or more baggage items;
receiving timing information including nominal transit times between reference nodes of the plurality of nodes;
producing individualized baggage tracking information including, for each of the one or more baggage items of the customer, one or more instances of status and timing information; and
communicating at least a portion of the individualized baggage tracking information to the customer.

16. The method of claim 15, wherein the individualized baggage transit information includes, for at least one baggage item of the customer, status information comprising indicia of one or more visited nodes of the baggage item and timing information comprising indicia of recorded arrival times of the baggage item at the visited nodes.

17. The method of claim 16, wherein the individualized baggage transit information comprises, in an instance of the at least one baggage item having reached a terminating node, indicia of recorded arrival time of the baggage item at the terminating node.

18. The method of claim 15, wherein the individualized baggage transit information includes, for at least one baggage item of the customer, status information comprising indicia of one or more nodes yet to be negotiated by the baggage item and timing information comprising indicia of projected arrival times of the baggage item at the visited nodes.

19. The method of claim 18, wherein the individualized baggage transit information comprises, in an instance of the at least one baggage item not yet having reached a terminating node, indicia of projected arrival time of the baggage item at the terminating node.
